(19) United States
(12) Patent Application Publication
(10) Pub. No.: US 2010/0236770 A1
(43) Pub. Date: Sep. 23, 2010

(54) METHOD AND SYSTEM FOR CONTROLLING AN AUTOMOTIVE HVAC SYSTEM

(75) Inventor: Ross Dykstra Pursifull, Dearborn, MI (US)

Correspondence Address: ALLEMAN HALL MCCOY RUSSELL & TUTTLE, LLP, 806 S.W. BROADWAY, SUITE 600, PORTLAND, OR, 97205, US

(73) Assignee: FORD GLOBAL TECHNOLOGIES, LLC, Dearborn, MI (US)

(21) Appl. No.: 12/407,257

(22) Filed: Mar. 19, 2009

(51) Int. Cl. B60H 1/00

(52) U.S. Cl. 165/202

(57) ABSTRACT

Systems and methods are provided for operating a heating, ventilation, and air-conditioning (HVAC) system of a vehicle. One example method comprises, during a first engine-running condition, operating the HVAC system to provide a passenger-requested level of thermal comfort; during a second vehicle-off condition, where a vehicle door or window is in a closed and/or locked position, maintaining operation of the HVAC system to continue providing the passenger-requested level of thermal comfort; and during a third vehicle-off condition, where a vehicle door or window is in an open and/or unlocked position, discontinuing operation of the HVAC system.

### FIELD

The present description relates generally to an automotive HVAC system.

### BACKGROUND/SUMMARY

Automotive heating, ventilation, and air conditioning (HVAC) systems aim to make vehicle occupants comfortable. To achieve this goal, HVAC control systems consider the relationship between comfort and variables that affect comfort.

Current HVAC control systems are configured to shut-off the automotive HVAC system under vehicle-off conditions, such as at key-off and/or key-out conditions. However, under conditions when a vehicle occupant has turned off the vehicle but has not yet exited the vehicle, (for example, due to cold and adverse weather conditions outside, carrying out a cell-phone call, looking up directions, etc.) the desired level of comfort to the occupant may degrade quickly and the occupant may become uncomfortable.

Thus, in one example, the issue may be addressed by a method of operating a heating, ventilation, and air-conditioning (HVAC) system of a vehicle. One example embodiment comprises, during a first engine-running condition, operating the HVAC system to provide a passenger-requested level of thermal comfort; during a second vehicle-off condition, where a vehicle door or window is in a closed and/or locked position, maintaining operation of the HVAC system to continue providing the passenger-requested level of thermal comfort; and during a third vehicle-off condition, where a vehicle door or window is in an open and/or unlocked position, discontinuing operation of the HVAC system.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1A shows a schematic view of a vehicle configured with an HVAC system.

FIG. 1B shows example configurations of vehicle-off conditions.

FIG. 2 shows an example embodiment of the HVAC system of FIG. 1.

FIG. 3 shows a high-level flow chart illustrating a routine that may be implemented for controlling an operation of a vehicle HVAC system.

### DETAILED DESCRIPTION

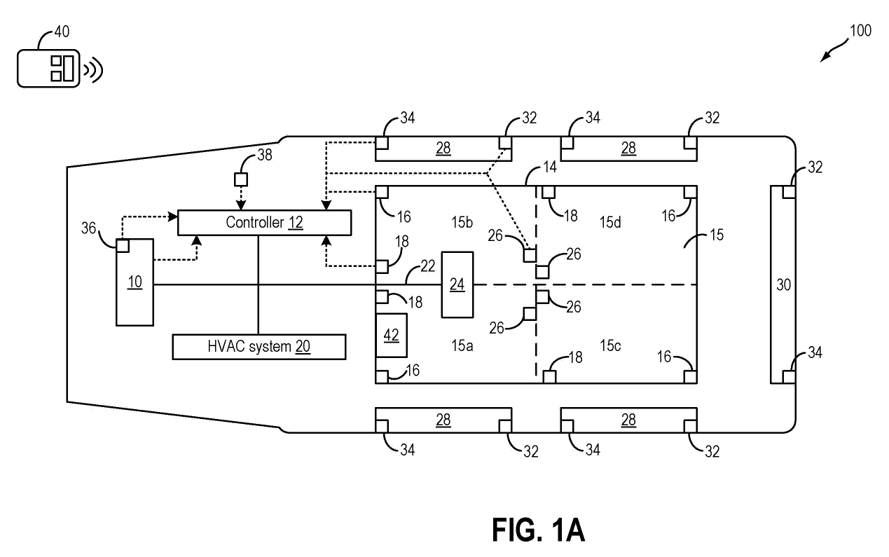

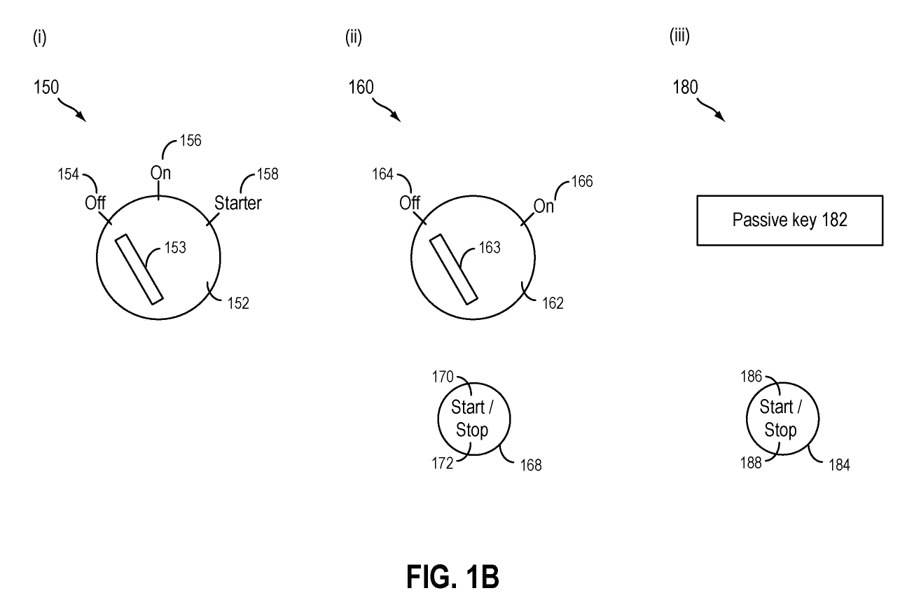

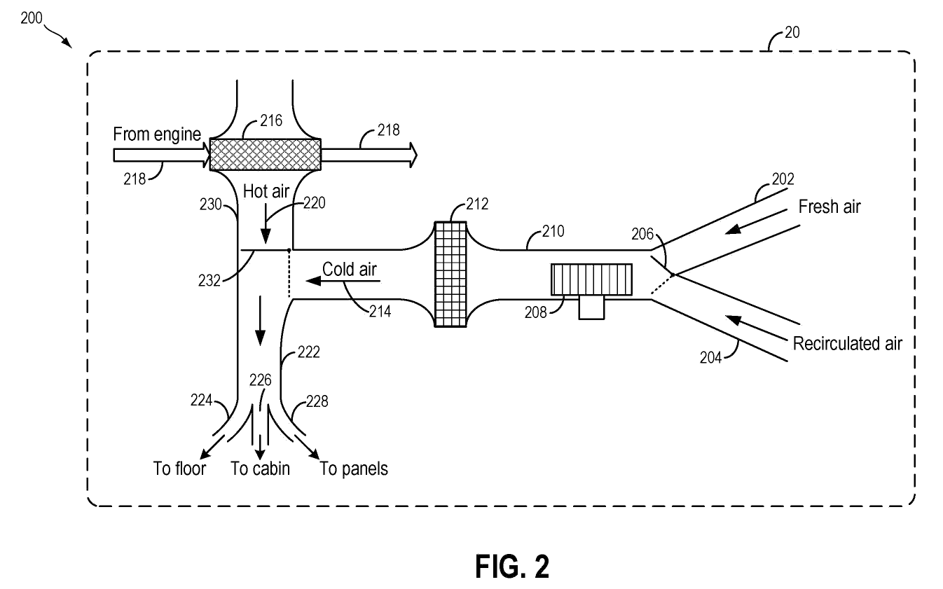

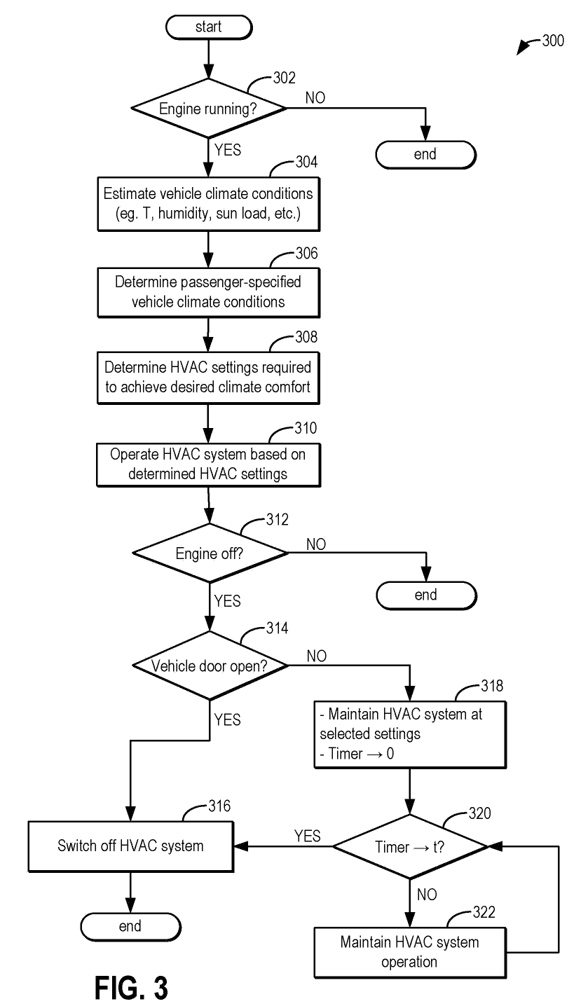

The following description relates to systems and methods for operating a vehicle HVAC system, such as depicted in FIGS. 1A and 2, to provide enhanced thermal comfort to vehicle occupants. Specifically, the HVAC system may be configured to continue operating during vehicle-off conditions (as depicted in FIG. 1B) following vehicle-on/operating conditions, as long as a vehicle occupant remains inside the vehicle, to enable the occupant to continue receiving the requested level of thermal comfort, until the occupant exits the vehicle. A controller may be configured to adjust operation of the HVAC system in coordination with engine and vehicle door and/or window settings using a control routine, such as is illustrated with reference to FIG. 3. By continuing to operate a vehicle HVAC system after vehicle-off but before vehicle door and/or window opening, the vehicle occupants may be provided with a more comfortable vehicle experience.

FIG. 1A shows a schematic depiction of a vehicle 100 equipped with an HVAC system 20. The vehicle may include a cabin space 14. The cabin space may be divided into occupancy zones 15. In one example, vehicle 100 may be a four-passenger vehicle. Accordingly, cabin space 14 may be divided into four occupancy zones including a front left side driver zone 15a, a front right side passenger zone 15b, a rear left side passenger zone 15c, and a rear right side passenger zone 15d. Each occupancy zone may be equipped with an occupancy sensor 16. In one example, occupancy sensor 16 may be a safety belt sensor configured to correlate the occupancy of the passenger zone with the fastening of the safety belt. Alternatively, other suitable occupancy sensors may be used.

HVAC system 20 may be configured to provide a climate-controlled air flow to cabin space 14 through ducting 22 and vent 24. While the depicted example shows a common vent for the entire cabin space, it will be appreciated that in alternate embodiments, each occupancy zone may be serviced by distinct vents (not shown) to enable each passenger to control the climate (for example, the temperature) of their occupancy zone. HVAC system 20 may additionally provide a climate-controlled air flow to the vehicle floors and panels (not shown) through appropriate ducting.

Cabin space 14 may be equipped with a temperature sensor 18 to provide feedback to a controller 12 regarding the temperature conditions in the cabin space. In one example, temperature sensor 18 may be a common temperature sensor providing feedback regarding the average ambient temperature of the cabin space. In another example, each occupancy zone may be equipped with a distinct temperature sensor 18 to provide feedback to controller 12 regarding the temperature conditions within each occupancy zone. Alternatively, the signal provided from the distinct temperature sensors 18 may be combined and arranged in controller 12 to provide a control input signal representative of the ambient temperature of the cabin space 14.

Cabin space 14 may also be equipped with sun load sensor 26 to provide a signal indicative of the solar load received from each window of a respective occupancy zone 15 to controller 12. The vehicle 100 may additionally be equipped with fore and aft sun load sensors on the front and back windows of the vehicle (not shown). The signal provided from the sun load sensors 26 may be combined and arranged in controller 12 to provide a control input signal representative of the solar radiation intensity on the vehicle interior. Alternatively, the signals from the distinct sun load sensors may be used individually as a control input signal representative of the solar radiation intensity of each occupancy zone 15. Alternatively, the fore and/or aft sun load sensor may be used to provide a combined or individual solar intensity signal to the controller 12.

The vehicle 100 may be configured with four doors 28. In alternate embodiments, the vehicle may be configured with two doors. Additionally, the vehicle 100 may include a rear door 30. As such, each door may include a window (not shown). Each vehicle door 28 and rear door 30 may include a door sensor 32 configured to provide an indication of the closed or open position of the door. Additionally, door sensor 32 may be configured to provide an indication of the locked or unlocked position of the door. Similarly, each vehicle window may include a window sensor 34 configured to provide an indication of the closed or open position of the window.

Additional sensors, such as a humidity sensor, an outside air temperature sensor, and an air quality sensor (not shown), may also be included in cabin space 14 (or each occupancy zone 15) and may provide inputs to the controller 12. Controller 12 may also receive an indication of the ignition status of engine 10 from an ignition sensor 36. Controller 12 may also communicate directly with engine 10 regarding the on/off status of the engine. Vehicle 100 may further include a key fob sensor 38 configured to receive input from electronic key fob 40. Specifically, key fob sensor 38 may remotely couple the vehicle 100 to electronic key fob 40, thereby enabling a remote keyless entry into vehicle 100. Key fob sensor 38 may be configured to provide an indication to controller 12 regarding the locked or unlocked position of doors 28.

Controller 12 may determine a vehicle condition at least partly based on the indication provided by the door sensor 32, window sensor 34, and/or key fob sensor 38, to accordingly determine whether to operate HVAC system 20, maintain the operation of HVAC system 20, or discontinue operation of HVAC system 20.

As further elaborated with reference to FIG. 1B, vehicle-off conditions may be indicated to controller 12 based on the position of a slot in the vehicle's keyhole, the presence or absence of a passive key in the vehicle, and/or the position of a vehicle start/stop button. A related position sensor (not shown) may communicate the respective positions to the controller.

FIG. 1B shows three example embodiments of vehicle-off configurations. As such, these configurations may be found in hybrid-drive enabled vehicle systems, non-hybrid enabled vehicle systems, and/or push-button engine start-enabled vehicle systems. It should also be appreciated that vehicle-off conditions are not one-to-one equivalent to engine-off conditions. For example, as described herein, engine-off conditions can occur under both vehicle-on and vehicle-off conditions, and particular advantages can be achieved during vehicle-off conditions.

At (i), a first example embodiment 150 of a vehicle-off condition is shown. Herein, an engine keyhole 152 may include a slot 153. By inserting a key, the position of the slot 153 may be varied between a first position 154 corresponding to a vehicle-off condition, a second position 156 corresponding to a vehicle-on condition, and a third position 158 corresponding to a starter-on condition. As such, to start cranking the engine, a vehicle key may be inserted in the keyhole 152 and slot 153 may be initially positioned at the third position 158 to start operating the engine starter. Following engine start, the slot may be returned to the second position 156 to signal that the engine is running. As such, during the (first) engine-running condition, the HVAC system may be operated to provide the passenger-requested level of thermal comfort. Following the engine-running condition, the vehicle may be turned off by moving the slot to the first position 154. As such, the (second) vehicle-off condition may be communicated to the controller by the presence of slot 153 in the first position 154, irrespective of whether the key is in the slot or pulled out of the slot. In one example, the (second) vehicle-off condition may immediately follow the (first) engine-running condition. During the vehicle-off condition, a controller may be configured to maintain operation of the HVAC system, to continue to provide the passenger-requested level of thermal comfort, until a door or window of the vehicle is opened or unlocked. In one example, the vehicle-off condition may be maintained for a threshold duration. When a vehicle door or window is determined to be in an open and/or unlocked position, following the slot 153 being positioned in first position 154, a (third) vehicle-off condition may be communicated to the controller, during which, operation of the HVAC system may be discontinued. It will be appreciated that during a fourth vehicle-on engine-off condition, that is, when slot 153 is positioned in second position 156 with the engine turned off, operation of the HVAC system may be provided/maintained. In one example, the HVAC system may be operated to recirculate stored hot or cold air. In another example, a blower motor and a heater core pump of the HVAC system may be operated to continue flowing engine coolant (with a significant amount of stored heat) to maintain heated airflow to the cabin. Again, in one example, the HVAC settings may be maintained until a vehicle door and/or window is opened.

At (ii), a second example embodiment 160 of a vehicle-off condition is shown. Herein, an engine keyhole 162 may include a slot 163. By inserting a key, the position of the slot 163 may be varied between a first position 164 corresponding to a vehicle-off condition, and a second position 166 corresponding to a vehicle-on condition. An additional button 168 may be provided that may be alternated between a start position 170 and a stop position 172 to accordingly start or stop the engine. As such, to start cranking the engine, a vehicle key may be inserted in the keyhole 162, slot 163 may be positioned at the second position 166, and button 168 may be pushed into start position 170 to start operating the engine starter. The HVAC system may then be operated during the engine-running condition. Following the engine-running condition, the engine may be stopped by pushing button 168 into the stop position 172. The HVAC system may continue to be operated during the engine-off condition. Following engine-off, a vehicle-off condition may be achieved by moving the slot to the first position 154. As such, the vehicle-off condition may be communicated to the controller by the presence of slot 163 in the first position 164, irrespective of whether the key is in the slot or pulled out of the slot. In one example, the vehicle-off condition may immediately follow the engine-running and engine-off condition. During the vehicle-off condition, a controller may be configured to maintain operation of the HVAC system until a door or window of the vehicle is opened or unlocked, or until a threshold duration has elapsed, for example. It will be appreciated that during a vehicle-on engine-off condition, that is, when slot 163 is positioned in second position 166 and button 168 is in stop position 172, operation of the HVAC system may be provided/maintained. In one example, the HVAC system may be operated to recirculate stored hot or cold air. In another example, the electrically powered blower motor and the electrically powered heater core pump of the HVAC system may be operated to maintain HVAC settings. In one example, the HVAC settings may be maintained until a vehicle door and/or window is opened.

At (iii), a third example embodiment 180 of a vehicle-off condition is shown. Herein, in place of an engine keyhole, a passive key 182 may be used to indicate the presence of a driver to the controller. An additional button 184 may be provided that may be alternated between a start position 186 and a stop position 188 to accordingly start or stop the engine. To start running the engine, the passive key may be present inside the vehicle, and button 184 may be pushed into start position 186 to start operating the engine starter. The HVAC system may then be operated during the engine-running condition. Following the engine-running condition, a vehicle-off (and also engine-off) condition may be indicated by the presence of passive key 182 inside the vehicle and the presence of button 184 at stop position 188. In one example, the vehicle-off condition may immediately follow the engine-running condition. A controller may continue to operate the HVAC system during the vehicle-off condition until a door or window of the vehicle is opened or unlocked, or until a threshold duration has elapsed, for example.

Returning to FIG. 1A, the vehicle 100 may include a climate-control interface 42 wherein settings for a level of thermal comfort desired in the cabin space may be selected. Therein, an amount of heating or cooling of the cabin space 14 may be requested. For example, a temperature (or temperature-range) of the cabin space may be selected. Additionally, a direction of air flow may be specified, for example, whether the air flow is directed towards the floor of the vehicle, the interior of the vehicle, or both. The settings may also specify a rate of air flow (for example, low, medium or high flow rates). Further, the settings may specify a ratio of fresh air (from outside the vehicle) to recirculated air (from inside the vehicle). Further still, the settings may specify the directing of the air flow towards vehicle panels for defrosting and/or defogging operations. In alternate embodiments, each occupancy zone 15 may include respective climate-control interfaces to enable each occupancy zone to be configured with respective climate-controlled zones.

Controller 12 may be a microprocessor based controller including a central processing unit (CPU) and associated memory, such as read only memory (ROM), random access memory (RAM), and keep alive memory (KAM), as well as input and output ports for receiving information from, and communicating information to, the various sensors, vents, and climate-control interfaces.

Controller 12 may operate HVAC system 20 in response to passenger-selected settings, for example, a temperature and direction of air flow. Specifically, in response to the passenger-selected settings, the controller may monitor and process the various inputs received from the plurality of sun load sensors, temperature sensors, humidity sensors, etc., to accordingly adjust the function of the HVAC heating and cooling components, such as the evaporator, the blower, and the heater (FIG. 2), to thereby provide the desired temperature and direction of air flow. As further elaborated with reference to FIG. 3, the controller may further operate the HVAC system responsive to the off/on status of vehicle 100 and the open/closed (and/or locked/unlocked) status of vehicle doors 28, rear door 30, and/or vehicle windows. Specifically, in response to a vehicle-off indication (for example, as determined based on the position of a slot in the vehicle's keyhole), the controller may continue HVAC system operation and maintain the selected temperature and direction of air flow in the cabin space. The HVAC system may be operated during the vehicle-off condition until the occupants exit the vehicle, that is, until a door or window of the vehicle is opened (for example, as determined based on input received from the door sensors and/or window sensors) or unlocked (for example, as determined based on input received from the key fob sensor).

In one example, when vehicle 100 is a hybrid vehicle, the controller may continue to operate the HVAC system using electrical energy from a system battery so as to enable the requested level of thermal comfort to be maintained, even when the engine is off (e.g., shut down and at rest). In another example, when vehicle 100 is not a hybrid vehicle, the controller may be configured to recirculate and reuse cold or hot air, stored HVAC system, to cool or heat the cabin space during the operation of the HVAC system after vehicle-off. The controller may include a timer to specify a threshold duration over which the stored cold or hot air may be reused, while the vehicle doors (and/or windows) remain closed. Operation of the HVAC system may be maintained until the threshold duration has elapsed, following which, operation of the HVAC system may be discontinued. The threshold duration may be adjusted vehicle responsive to vehicle operating conditions including at least one of a vehicle battery state of charge, an amount of stored cooling/heating capacity, temperature of stored refrigerant, an ambient vehicle air temperature, an ambient outside air temperature, and temperature of air delivered to the cabin via the HVAC system. In this way, a vehicle HVAC system may be operated during vehicle-off conditions to enable a passenger, still occupying the vehicle, to receive the requested level of comfort until they exit the vehicle.

Now turning to FIG. 2, an example embodiment 200 of the components and operation of a vehicle HVAC system 20 is described. As such, the temperature and flow of air supplied to the vehicle's cabin space may be adjusted by adjusting a ratio of hot air (generated using heating elements) and cold air (generated using cooling elements). HVAC system 20 includes a fresh air duct 202 for providing fresh air from outside the vehicle, and a recirculated air duct 204 for providing recirculated air from inside the vehicle cabin. A ratio of fresh air to recirculated air is adjusted by actuator 206 responsive to selected HVAC settings. For example, when a higher proportion of recirculated air is needed, the actuator may be positioned near the mouth of fresh air duct 202 (as shown in solid lines). Alternatively, when a higher proportion of fresh air is needed, the actuator may be positioned near the mouth of recirculated air duct 204 (as shown in dotted lines). Actuator 206 may be driven between the various positions by a vacuum motor (not shown). Alternatively, actuator 206 may be driven by an electric servo motor.

The appropriate mixture of fresh and recirculated air is then passed through HVAC cooling elements, configured to enable air conditioning. Specifically, the air is passed through blower 208 and evaporator core 212 along conduit 210. Blower 208 includes a variable speed blower motor and a blower wheel or fan. Inside evaporator core 212, the evaporation of a low pressure cooling fluid or refrigerant (for example, freon) into a low pressure gas causes a cooling effect which in turn cools the air flowing across it. Based on the temperature settings of the HVAC system, a suitable proportion of cold air 214, cooled by passage through evaporator core 212, may then be passed into ducting 222. Further, in the example of an electrically powered blower motor, even when the engine is stopped, cold air stored in the cold air conduit may be available to cool airflow to the passenger compartment.

Similarly, hot air 220 may be generated by passage of fresh and/or recirculated air through HVAC heating elements, configured to enable air heating. Specifically, air is passed through a heater core 216. Engine coolant 218, received from the engine, is circulated through the heater core. A coolant pump may be configured to circulate engine coolant through the heater core 216. For example, in vehicles performing start-stop operation (e.g., where the engine is shutdown at stopped vehicle conditions, automatically, and then automatically restarted when an operator requests a vehicle launch), a 12 watt engine coolant pump may be used as a heater core pump to circulate engine coolant through the heater core. Heater core 216 may then behave as a heat exchanger, withdrawing heat from the engine coolant and transferring the withdrawn heat to air passing across it. In this way, hot air may be generated in conduit 230 and passed into ducting 222. Further, in the example of an electrically powered coolant pump, even when the engine is stopped, heat stored in the entire coolant path may be available to heat airflow to the passenger compartment. A climate-controlled air flow comprising a suitable amount of hot air and cold air may be generated in ducting 222, for subsequent passage to vehicle vents. Specifically, a ratio of hot air 220 to cold air 214 may be adjusted by actuator 232 responsive to selected HVAC settings. For example, when air flow of a higher temperature is requested, the actuator may be positioned near the mouth of cold air conduit 210 (as shown in dotted lines). Alternatively, when air flow of a lower temperature is requested, the actuator may be positioned near the mouth of hot air conduit 230 (as shown in solid lines). Actuator 232 may be driven by a vacuum motor or an electric servo motor (not shown). The air flow with the requested settings of flow rate and temperature may then be directed along ducting 224, 226 and/or 228 to the vehicle floor, cabin space and panels, respectively, responsive to the passenger-indicated direction of air flow.

In this way, the heating and cooling elements of HVAC system 20 may be used to deliver an air flow with an appropriate ratio of hot and cold air to a requested location, with a requested flow rate, to thereby provide the vehicle passengers with a climate-controlled air flow.

Now turning to FIG. 3, an example routine 300 is described for operating a vehicle HVAC system according to the present disclosure. Specifically, the routine enables the HVAC system to be operated even after a vehicle-off condition, until a vehicle door is opened. In doing so, the vehicle occupant may be able to receive continued thermal comfort in the vehicle, thereby enhancing the occupant's drive experience.

At 302, it may be confirmed whether the engine is running. If not, the routine may end. Else at 304, the vehicle climate conditions may be estimated and/or determined. These may include estimating a vehicle cabin temperature, humidity, sun load, air quality, etc., as sensed by respective sensors. At 306, the passenger-specified vehicle climate conditions may be determined, as indicated by the settings selected by an occupant (that is, vehicle passenger) on a climate-control interface. At 308, based on the input received regarding the prevalent vehicle climate conditions, and further based on the climate conditions requested, suitable HVAC settings required to achieve the desired climate comfort may be determined. These may include, for example, determining a ratio of hot air to cold air to be generated by HVAC system heating and cooling elements respectively, and/or a ratio of fresh air to recirculated air to be mixed into the air flow. These may further include, for example, determining a rate and direction of the air flow. Accordingly, at 310, the HVAC system may be operated based on the determined HVAC settings. In one example, where a single (centralized) climate-control interface and a single (centralized) vent may be provided in the cabin space, the HVAC system may be operated to provide the desired climate-controlled air flow in the vehicle cabin space. In another example, where each occupancy zone is configured with individual vents and climate-control interfaces, the HVAC system may be operated to enable each occupancy zone to be ventilated with respective selected settings, to thereby provide individual climate-controlled zones.

At 312, it may be confirmed whether a vehicle-off condition has been perceived. In one example, a vehicle-off condition may be estimated and/or inferred from the position of a slot in the vehicle's keyhole, the position of an engine start/stop button, an engine ignition status as provided by the engine directly, and/or an ignition sensor, or any combination thereof. If the engine is not turned off, the routine may end. If a vehicle-off condition is confirmed, at 314, it may be determined whether a vehicle door or window is open and/or unlocked. In one example, the open status of a vehicle door may be sensed by a door sensor while the open status of a vehicle window may be sensed by a window sensor. In another example, the open status of a vehicle door may be inferred by a passenger unlocking a previously locked door. Further still, the open status of a door may be inferred from a door unlocking signal received from an electronic key fob via a key fob sensor. As such, any door and/or window may be opened for a door open and/or window open status to be confirmed.

If a door is opened, then at 316, the HVAC system may be switched off thereby discontinuing the operation of the HVAC system. If the door is not opened, then at 318, the HVAC system may be maintained at the selected settings and operation of the HVAC system may continue. In one example, where the vehicle has a hybrid drive system, the HVAC system may continue to be operated using the electrical power from a system battery. In another example, where the vehicle does not have a hybrid drive system, the HVAC system may provide thermal comfort using the stored cold and/or hot air generated before the engine-off condition. In either case, to further limit battery discharge (for example, in the hybrid drive enabled system) and to maintain fuel economy after depletion of the stored cold and/or hot air (for example, in the non-hybrid drive enabled system), the operation of the HVAC system may be maintained for a threshold duration, by starting a timer. At 320, it may be determined whether the timer has reached a threshold t, that is, whether the threshold duration has elapsed. As such, threshold t may correspond to a time beyond which the battery may be discharged to a threshold state of charge (for example, in the hybrid drive enabled system) and/or beyond which the stored cold and/or hot air may be depleted (for example, in the non-hybrid drive enabled system). The threshold duration may be adjusted based on vehicle operating conditions, for example, a vehicle battery state of charge, an amount of stored heating/cooling capacity, temperature of stored refrigerant, an ambient vehicle air temperature, an ambient outside air temperature, and temperature of air delivered to the cabin via the HVAC system. If the timer has reached the threshold time t, that is, if the threshold duration has elapsed, then the routine may proceed to 316 to switch off and thereby discontinue operation of the HVAC system. If the threshold time t is not reached, then at 322, the HVAC system may continue operation until the threshold time t is reached.

In one example, a passenger may start running a vehicle engine, and specify settings (such as temperature and direction) of a desired air flow. Accordingly, during the first engine-running condition, the HVAC system may be operated to provide the passenger-requested level of thermal comfort. Following the first engine running condition, the passenger may switch off the engine and remove a vehicle key from the keyhole, but remain in the vehicle. Herein, a second vehicle-off condition may be identified. During this second vehicle-off condition, operation of the HVAC system may be maintained to continue providing the passenger with the passenger-requested level of thermal comfort. Following the second vehicle-off condition, the passenger may unlock and open the vehicle door to exit the vehicle. Herein, a third vehicle-off condition may be identified. During this second vehicle-off condition, operation of the HVAC system may be discontinued.

In this way, a vehicle HVAC system may be operated even after the engine of a vehicle has been turned off to enable vehicle occupants to enjoy a climate-controlled air flow until they have exited the vehicle. By switching off the HVAC system responsive to the open and/or unlocked status of a vehicle door, a comfortable vehicle climate experience of the vehicle occupant may be prolonged, thereby enhancing their vehicle drive experience.

Note that the example control and estimation routines included herein can be used with various engine and/or vehicle system configurations. The specific routines described herein may represent one or more of any number of processing strategies such as event-driven, interrupt-driven, multi-tasking, multi-threading, and the like. As such, various acts, operations, or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated acts or functions may be repeatedly performed depending on the particular strategy being used. Further, the described acts may graphically represent code to be programmed into the computer readable storage medium in the engine control system.

It will be appreciated that the configurations and routines disclosed herein are exemplary in nature, and that these specific embodiments are not to be considered in a limiting sense, because numerous variations are possible. For example, the above technology can be applied to various vehicle types, such as hybrid, plug-in hybrid, non-hybrid, and the like. Further, door opening indications can be based on various parameters, such as a door-ajar sensor, a door handle position sensor, and/or others. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method of operating a heating, ventilation, and air-conditioning (HVAC) system of a vehicle, the method comprising, during a first engine-running condition, operating the HVAC system to provide a passenger-requested level of thermal comfort;
during a second vehicle-off condition, where a vehicle door or window is in a closed and/or locked position, maintaining operation of the HVAC system to continue providing the passenger-requested level of thermal comfort; and
during a third vehicle-off condition, where a vehicle door or window is in an open and/or unlocked position, discontinuing operation of the HVAC system.

2. The method of claim 1 wherein the vehicle door includes a door sensor configured to provide an indication of the closed or open position of the door, and wherein the vehicle window includes a window sensor configured to provide an indication of the closed or open position of the window, and where the third condition is identified based on the indication provided by the door sensor and/or window sensor.

3. The method of claim 1 wherein the vehicle includes a key fob sensor, the key fob sensor remotely coupling the vehicle to an electronic key fob, the key fob sensor further configured to provide an indication of the locked or unlocked position of the door, and where the third condition is identified based on the indication provided by the key fob sensor.

4. The method of claim 1 wherein during the second engine-off condition, maintaining operation of the HVAC system includes maintaining operation of the HVAC system for a threshold duration.

5. The method of claim 4 further comprising, discontinuing operation of the HVAC system after the threshold duration has elapsed.

6. The method of claim 4 wherein the threshold duration is adjusted responsive to vehicle operating conditions including at least a vehicle battery state of charge, where the vehicle is a hybrid vehicle powering HVAC cooling/heating via a motor and not the engine.

7. The method of claim 1 further comprising, during a fourth vehicle-on engine-off condition, maintaining operation of the HVAC system by energizing a blower motor and a heater core pump of the HVAC system.

8. A vehicle system, comprising:
an engine;
a heating, ventilation, and air-conditioning (HVAC) system;
a plurality of vehicle doors; and
a computer readable storage medium having code therein, the medium comprising:
code for operating the HVAC system during a first engine-running condition to provide a passenger-requested level of thermal comfort;
code for maintaining operation of the HVAC system during a second vehicle-off condition, where a vehicle door or window is closed and/or locked, to continue providing the passenger-requested level of thermal comfort; and
code for discontinuing operation of the HVAC system, during a third vehicle-off condition, where a vehicle door or window is open and/or unlocked.

9. The system of claim 8 wherein the plurality of vehicle doors are each coupled to a door sensor, the door sensor configured to provide an indication of the open or closed status of the vehicle door to the computer readable storage medium.

10. The system of claim 9 wherein each of the plurality of vehicle doors are coupled to a vehicle window, each vehicle window coupled to a window sensor, the window sensor configured to provide an indication of the open or closed status of the vehicle window to the computer readable storage medium.

11. The system of claim 10 wherein the third condition is identified based on the indication provided by the door sensor and/or window sensor, wherein the vehicle is a non-hybrid vehicle, and where the vehicle is an engine start-stop vehicle.

12. The system of claim 8 further comprising a key fob sensor, the key fob sensor remotely coupling the vehicle system to an electronic key fob, the key fob sensor configured to provide an indication of the locked or unlocked position of the vehicle door, and where the third condition is identified based on the indication provided by the key fob sensor.

13. The system of claim 8 wherein, during the second vehicle-off condition, maintaining operation of the HVAC system includes maintaining operation of the HVAC system for a threshold duration, the computer readable storage medium further comprising code for discontinuing operation of the HVAC system after the threshold duration has elapsed.

14. The system of claim 13 wherein the threshold duration is adjusted responsive to vehicle operating conditions, including a vehicle battery state of charge, where the duration is increased for a higher state of charge.

15. The system of claim 13 wherein the threshold duration is adjusted responsive to vehicle operating conditions, including an amount of stored cooling capacity, where the duration is increased for a higher amount of stored cooling capacity.

16. The system of claim 13 wherein the threshold duration is adjusted responsive to vehicle operating conditions, including temperature of stored refrigerant, where the duration is increased for a lower temperature.

17. The system of claim 13 wherein the threshold duration is adjusted responsive to vehicle operating conditions, including an ambient vehicle air temperature, an ambient outside air temperature, and temperature of air delivered to the cabin via the HVAC system.

18. The system of claim 8 further comprising an electrically powered blower motor and an electrically powered heater core pump, and wherein the medium further comprises code for energizing the blower motor and the heater core pump during a fourth vehicle-on condition where the engine is off.

19. A method of operating a heating, ventilation, and air-conditioning (HVAC) system of a vehicle, the vehicle comprising a plurality of doors and a plurality of windows, each of the plurality of doors coupled to a door sensor, each of the plurality of windows coupled to a window sensor, the method comprising,
during a first engine-running condition, operating the HVAC system to provide a passenger-requested level of thermal comfort;
during a second vehicle-off condition following the first engine-running condition, where a vehicle door or window is in a closed and/or locked position, maintaining operation of the HVAC system to continue providing the passenger-requested level of thermal comfort; and
during a third vehicle-off condition following the second vehicle-off condition, where a vehicle door or window is in an open and/or unlocked position, discontinuing operation of the HVAC system.

20. The method of claim 19 wherein the door sensor is configured to provide an indication of the open or closed status of the vehicle door, and wherein the window sensor is configured to provide an indication of the open or closed status of the vehicle window, and further wherein the third condition is identified based on the indication provided by the door sensor and/or window sensor, and wherein the HVAC system has cooling operation via a source other than an engine of the vehicle.

21. The method of claim 19 wherein the vehicle further includes a key fob sensor, the key fob sensor remotely coupling the vehicle to an electronic key fob, the key fob sensor configured to provide an indication of the locked or unlocked position of the vehicle door, and where the third condition is identified based on the indication provided by the key fob sensor.

22. The method of claim 19 wherein, during the second vehicle-off condition, maintaining operation of the HVAC system includes maintaining operation of the HVAC system for a threshold duration, the method further comprising, discontinuing operation of the HVAC system after the threshold duration has elapsed, wherein the threshold duration is adjusted responsive to vehicle operating conditions, including at least one of a vehicle battery state of charge.
